(19) United States
(12) Patent Application Publication
(10) Pub. No.: US 2011/0216059 A1
(43) Pub. Date: Sep. 8, 2011

(54) SYSTEMS AND METHODS FOR GENERATING REAL-TIME THREE-DIMENSIONAL GRAPHICS IN AN AREA OF INTEREST

(75) Inventors: Luisito D. Espiritu, Clearwater, FL (US); Sylvia A. Traxler, Seminole, FL (US); James W. Nelson, Tierra Verde, FL (US); Charles Hamilton Ford, Saint Petersburg, FL (US)

(73) Assignee: Raytheon Company, Waltham, MA (US)

(21) Appl. No.: 12/716,977

(22) Filed: Mar. 3, 2010

(51) Int. Cl. G06T 17/00; G06T 15/70

(52) U.S. Cl. 345/419; 345/473; 345/633

(57) ABSTRACT

Systems and methods for generating real-time 3D representation of a user immersed in a 3D representation of an area of interest are provided. In some embodiments, a method may be provided where the method provide steps for generating a three-dimensional area of interest based at least on substantially real-time data, generating an avatar immersed in the generated three-dimensional area of interest for each user of a plurality of users, animating each avatar immersed in the generated three-dimensional representation of area of interest based at least on gesture data received from one or more cameras associated to each user of the plurality of users, and manipulating objects represented in the three-dimensional representation of the area of interest.

### TECHNICAL FIELD

The present disclosure relates generally to graphics processing, and more particularly to systems and methods for generating substantially real-time, three-dimensional graphics of a user immersed in a three-dimensional graphical representation of an area of interest.

### BACKGROUND

Command and control applications may often include on-location planning and generally require test runs, an assessment of the current conditions at the specific location, and on-demand changes based on the current conditions. Often, the command and control may involve multiple planning parties, some of which may be located remotely from the specific location. For example, in a military environment, the planning of a mission may require knowledge of the location of the mission, the terrain of the location, and personnel involvement. Generally, a “sand table” at the location is constructed and objects such as rocks, twigs, and the like may be used to represent buildings, terrains, and other objects or obstacles present at the location, while tactical and strategic assets may be represented with toy models. Command and control of the mission is executed over the sand table. However, issues such as the safety and availability of the specific location and/or travel restrictions to the specific location may arise causing the delay in the events and planning process.

### SUMMARY

In accordance with the teachings of the present disclosure, the disadvantages and problems associated with command and control applications have been reduced or eliminated. In some embodiments, a method is provided. The method may include the steps of receiving substantially real-time data related to an area of interest and generating a three-dimensional representation of the area of interest using the received data. The method may also include steps for receiving substantially real-time data such as gesture data related to a plurality of users, each of the plurality of users located in a remote location, generating a three-dimensional representation of each of the plurality of users based at least one the received data, and displaying the three-dimensional representation of each of the plurality of users immersed in the three-dimensional representation of the area of interest.

In some embodiments, a method may be provided where the method provide steps for generating a three-dimensional area of interest based at least on substantially real-time data, generating an avatar immersed in the generated three-dimensional area of interest for each user of a plurality of users, animating each avatar immersed in the generated three-dimensional representation of area of interest based at least on gesture data received from one or more cameras associated to each user of the plurality of users, and manipulating objects represented in the three-dimensional representation of the area of interest.

In other embodiments, a system is provided. The system may include system may include a camera configured to capture real-time data related to a user of a plurality of users, a real-time imaging system configured to provide substantially real-time data related to an area of interest, and a processing unit coupled to the camera and real-time imaging system. The processing unit may be configured to receive the substantially real-time data related to an area of interest from the real-time imaging system and generate a three-dimensional representation of the received data related to an area of interest. The processing unit may also receive as input the substantially real-time data (e.g., gesture data) related to a plurality of from the camera, wherein each of the plurality of users located in a remote location and generate a three-dimensional representation of each of the plurality of users based at least one the received data. Subsequently, the processor may display the three-dimensional representation of each of the plurality of users immersed in the displayed three-dimensional representation of the area of interest.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example overview of a system for rendering 3D avatars of multiple users immersed in a substantially real-time display of an environment, in accordance with embodiments of the present disclosure;

FIG. 2 illustrates a block diagram of a system configured for immersing graphical representation of users in a three-dimensional, real-time area of interest, in accordance with certain embodiments of the present disclosure; and

FIG. 3 illustrates a flow chart of another example method for immersing graphical representation of users in a three-dimensional, real-time area of interest, in accordance with embodiments of the present disclosure.

### DETAILED DESCRIPTION

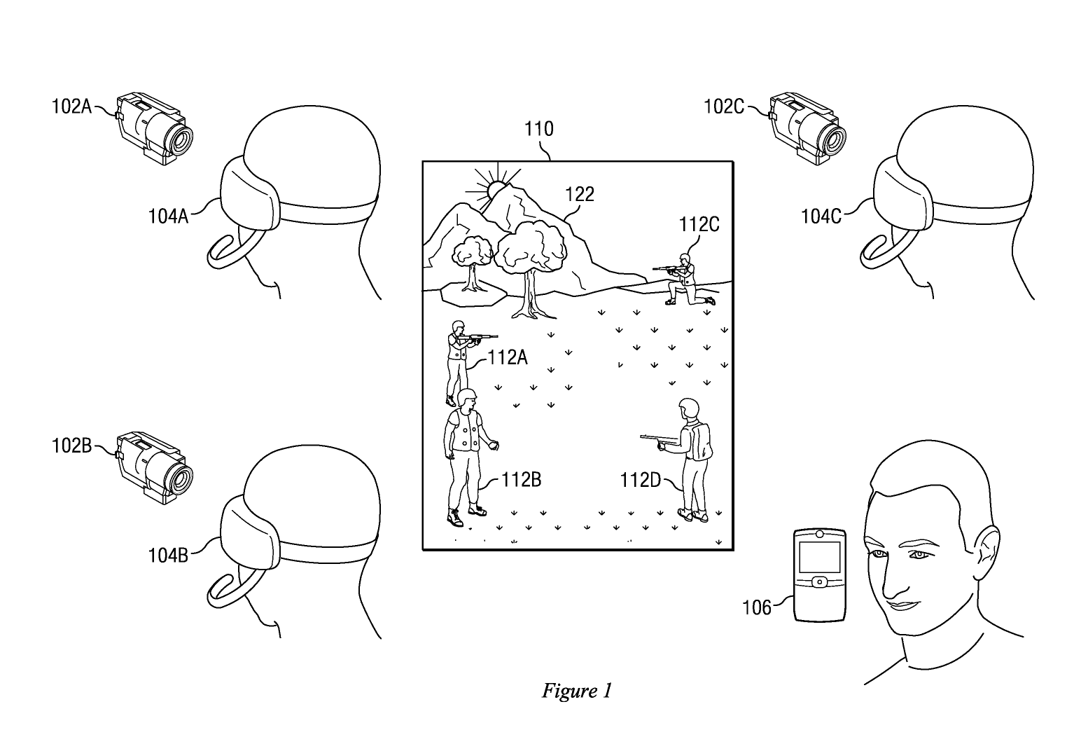

Preferred embodiments and their advantages are best understood by reference to FIGS. 1 through 3, wherein like numbers are used to indicate like and corresponding parts.

Referring to FIG. 1, an example overview of a system for rendering 3D avatars 112 of multiple users immersed in a substantially real-time display of an environment, in accordance with certain embodiments of the present disclosure. System 100 may include camera(s) 102 configured to capture the motion or gestures of an associated user, computing device(s) 106 configured to allow an associated user access to the display area 110 and allow the user to manipulate objects shown on display area 110, and head mounted device(s) 104 configured to allow visual and/or audible communication with other users. In general, system 100 may be configured to generate and display a virtual three-dimensional (3D) representation, e.g., an avatar 112 of a user in a substantially real-time generation of an area of interest 122. In particular, system 100 may provide for the networking of two or more remote users, displaying a representation of the users in the generated area of interest, and allowing the users to manipulate objects and the vantage point within the generated area of interest.

One example use of system 100 includes military mission control, where a command and control team having one or more commanders, officers, and/or other military or government officials are each located in remote locations and are planning mission scenarios.

The system and method may provide the ability to remotely plan, command, and/or control a military mission remotely over the virtual “sand box,” e.g., display of the battlegrounds, and the representation of the users immersed on the battlegrounds. Additionally, ground crews may also have access to the system and may provide feedback and/or insight to the command and control based on the manipulation of the command and control team.

Another example of use of system 100 includes air traffic control. By generating a substantial real-time depiction of an air space control areas, restricted fly zones, in-flight aircrafts, and weather conditions, e.g., the area of interest, air traffic controllers located at various locations may be able to manipulate an aircraft and plan for different trajectories, and visually share the proposed manipulations to all users or air traffic controllers of the system.

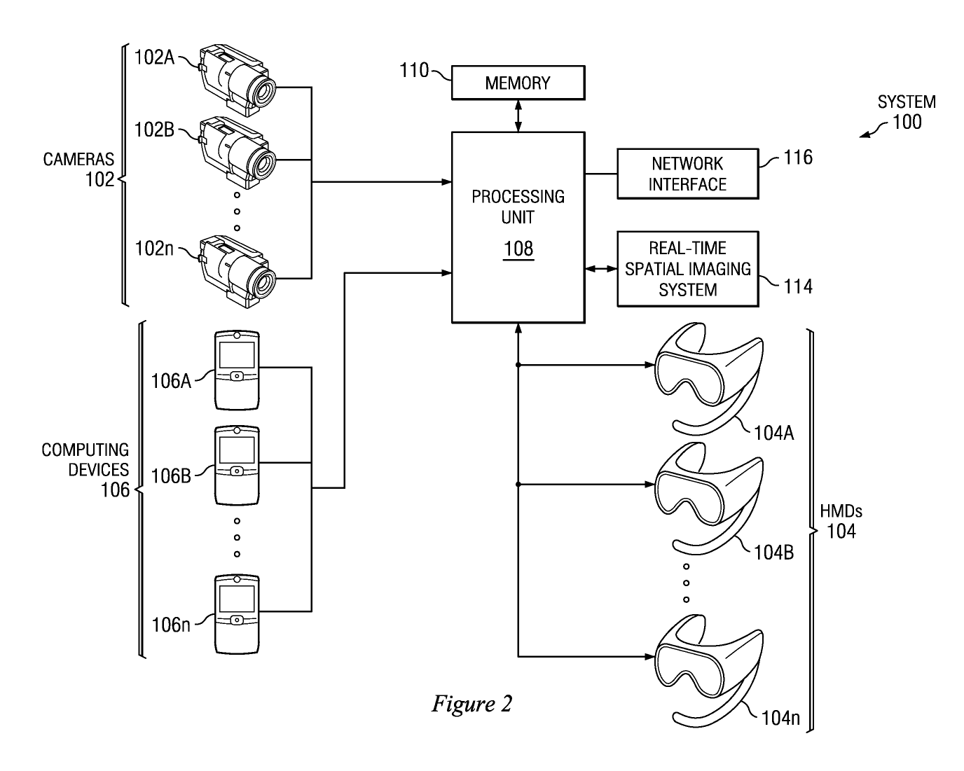

FIG. 2 illustrates a block diagram of a system 100 configured for immersing users in a three-dimensional, real-time area of interest, in accordance with certain embodiments of the present disclosure. As mentioned above, system 100 may include cameras 102, head mounted devices 104, and computing devices 106 to enable collaboration of multiple users in an environment. System 100 may also include processing unit 108, memory 112, sensor system 114, and network interface 116. System 100 may also include various hardware, software, and/or firmware components configured to generate an avatar of an associated user and animate the avatar to mirror the gestures of the associated user. System 100 may also include various hardware, software, and/or firmware configured to provide real-time data related to changes to a specific location. The real-time data may be dynamically integrated to a generated area of interest 122, which graphically represents a specific location.

Cameras 102 may be any type of video camera configured to capture gestures of an associated user. Camera 102 may provide the stream of images and/or video data to processing unit 108, which may generate an avatar for the associated user as well as animate the avatar based on the gestures captured by camera 102. In some embodiments, cameras 102 may capture the user moving objects rendered in the generated area of interest, pointing to objects rendered in the generated area of interest for other users to note, and/or other gestures. The gestures captured by cameras 102 may subsequently be used to animate avatars 112 created for each user, where avatars 114 mimic the gestures of the associated users.

In some embodiments, camera 102 may be an analog or digital video camera, a security camera, a webcam, or video camera. Camera 102 may also be a high-resolution digital camera capable of capturing accurate and high-resolution images of the associated user. In other embodiments, camera 102 may be a low resolution, monochrome, or infrared digital camera, which may reduce the processing complexity and/or provide alternative visual effects. Camera 102 may also be a time-of-flight camera or other specialized 3D camera. In some embodiments, more than one camera 102 may be used to capture the gestures including an associated user. For example, six cameras may be arranged in a space around a user (e.g., office, meeting room, vehicle such as a HMVEE, etc.) to capture gestures of the user.

Head mounted devices 104 may include 3D active stereo glasses allowing a user to view avatars 112 and generated area of interest 122, a microphone for relaying voice messages to other users of system 100, and/or earphones for receiving audio communication. Head mounted devices 104 may be configured to allow a user to interface with system 100 via for example, a cable, infrared communication, radio frequency communication, Bluetooth communication and/or any other wired or wireless communication means. In some embodiments, head mounted devices 104 may allow a user to change his/her vantage point based on, for example, the direction the head-mounted device is facing, zoom percentage, and the movement and gestures of the user wearing head mounted device 104.

In some embodiments, some head mounted devices 104 may restrict what a user may experience based on, for example, the credentials of the user, where head mounted device 104 may filter certain data (e.g., communication to users of system 100) such that access may be restricted as needed. For example, in a military operation, head mounted devices 104 may filter the planning sessions to certain military personnel (e.g., allowing access to commanders and restricting access by a ground crew), while control and command may be conducted by another group (e.g., battalion leader).

Computing devices 106 may any device any system or device that allow a user without a head mounted device 104 access to system 100. In some embodiments, computing device 106 may allow a user to view the generated area of interest 122 and avatars 112 representing other users of system 100 via, for example, a 2D or 3D display are associated computing device (e.g., touch screen, monitors, etc.). Computing devices 106 may also allow a user to communicate and interact with other users and manipulate objects rendered in generated area of interest 122 using an input device associated with the computing device such as, a touch screen, mouse, keyboard, trackball, and/or microphone. For example, a user may use a touchpad to select an object and move the selected object to a second location. In some embodiments, computing device 106 may be a mobile telephone (e.g., a Blackberry or iPhone), a personal digital assistant, a desktop, laptop, and/or other similar devices.

Processing unit 108 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiment, processing unit may receive gesture data from cameras 102. Processing unit 108 may generate and animate an avatar associated with the user based on the gesture data, where the gestures may allow the user to control objects in area of interest 122 (e.g., moving objects from one location to another), communicate with other users, and/or change the vantage point of the user. As an example only, processing unit 108 may execute Virtisim 3D simulation software made by Motion Reality Inc. (Marietta, Georgia) to provide such avatars and associated gestures.

Processing unit 108 may also receive audio data from head mounted device 104 to allow users of system 100 to communicate with one another. In some embodiments, processing unit 108 may process the audio data received from a microphone of head mounted device 104 and relay the audio data to the intended listener(s), and more specifically, the earphones of head mounted device 104 of the intended listener(s).

Processing unit 108 may also receive data input from computing devices 106. In some embodiments, a user may manipulate objects rendered in generated area of interest 122 using computing devices 106. The manipulation may be sent to processing unit 108, which may process the data, retrieve any graphical icons and/or symbols from memory 120, and display the changes.

Processing unit 108 may receive data from real-time spatial imaging system 114. Imaging system 114 may provide data related to a change to a location including, for example, an introduction of a new object, the removal of an object, the movement of an object, weather conditions, and/or other real-time data. The updates to the location may be dynamically integrated with the static, 3D generated area of interest 122. Details of imaging system 114 are described below.

Real-time spatial imaging system 114 may be any system, device, firmware and/or apparatus operable to provide updates to the area of interest, so that the monitoring and controlling of ground, sea, under-sea, space, and aerial units can occur in substantially real-time. In some embodiments, imaging system 114 may provide visual capabilities using mapping systems (e.g., Google Earth™), GPS data, satellite information, and other real-time data received from other sensor systems. Real-time imaging system 114 may also provide other area of interest data including, for example, loitering munitions locations, battlefield geometries, sensor locations and coverage, aircraft locations, satellite and UAV imagery, targeting information, and/or intelligence information. This information may be based on surveillance camera or intelligence and inputted in real-time imaging system 114 for rendering in area of interest 122. In some embodiments, real-time spatial imaging system 114 may be Raytheon's Total Battlespace Situational Awareness and/or Raytheon's Data Immersion Visualization Enhancement (DIVE) analysis system.

Network interface 116 may be any suitable system, apparatus, or device operable to serve as an interface between system 100 and a network. Network interface 116 may enable system 100, and in particular, components of system 100 to communicate over a wired and/or a wireless network using any suitable transmission protocol and/or standard, including without limitation all transmission protocols and/or standards known in the art. Network interface 116 and its various components may be implemented using hardware, software, or any combination thereof.

Memory 120 may be communicatively coupled to processing unit 108 and may comprise any system, device, or apparatus operable to retain program instructions (e.g., computer-readable media) or data for a period of time. Memory 120 may comprise random access memory (RAM), electrically erasable programmable read-only memory (EEPROM), a PCMCIA card, flash memory, magnetic storage, opti-magnetic storage, or any suitable selection and/or array of volatile or non-volatile memory that retains data after power to system 104 is powered down or off. In some embodiments, memory 120 may store graphic libraries, such as, for example, geographical maps, terrain maps, standardized avatar representations, buildings, planes, and other graphical symbols and icons that may be used to generate avatars 112 and/or an area of interest 122.

In operation, after a location is selected, processing unit 108 may generate a substantially real-time depiction of the location, e.g., a static, graphical representation of the location, referred to as an area of interest 122, current objects (e.g., buildings or other landmarks) located in the location using, for example, GPS coordinates, and/or terrain information stored in memory 120. For example, processing unit 108 may access memory 120 and may retrieve graphical icons and symbols to create a graphical representation of the selected location (e.g., generated area of interest 122) as well as a graphical representation of the objects in the selected location, creating a static image.

In some embodiments, processing unit 108 may also determine the attributes of some or all of the objects in the location. For example, in an air traffic control scenario, processing unit 108 may identify the type of aircraft, the origination and/or destination of the aircraft, the specific organization associated with the aircraft, etc. Each attribute may be stored in memory 120 and may be accessible to a user of system 100. In other embodiments, if an object in the location is unidentified, e.g., there are no known attributes stored in memory 120 for a particular object, system 100 may alert a user (e.g., via head mounting devices 104) that there is an unknown object that needs identification in area of interest 122.

In some embodiments, system 100 may be configured to monitor any changes to the static image. For example, processing unit 108 may receive data from real-time imaging system 114 related to the area of interest, including for example, weather conditions, the introduction, removal, or changes in location of objects (e.g., aircraft movement in an overspace, etc.), and/or other changes to the location. Based on the information received from real-time imaging system 114, processing unit 108 may dynamically generate a real-time 3D depiction of the changes (e.g., weather, location, movement) and integrate the real-time 3D depiction to generated area of interest 122.

Processing unit 108 may also receive data from one or more cameras 102. In some embodiments, the data may be the gesture(s) of the user captured by the associated camera 102. Based on the information received from cameras 102, processing unit 108 may retrieve graphical depiction of the users including graphical depictions of the gesture(s) from memory 120 and may provide the graphical representation, an animated avatar 112, to head mounting devices 104 and/or computing devices 106. In some embodiments, the graphical representation of the user may be immersed in the graphical representation of the area of interest.

A user associated with avatar 112 may see the graphical representation of area of interest 122 and the animated avatars 112 using head mounted device 104. In some embodiments, during a planning session or a meeting with other users of system 100, some or all users may wear the head mounted devices 104 and may communicate via a microphone and earphone pieces coupled to head mounted devices 104. In some embodiments, a user may be able to manipulate objects shown in area of interest 122. For example, for the head mounted device 104, a user may able to see an object and may be able to relocate the object to a second location. Camera 102 may be configured to capture this gestures provide the gestures to processing unit 108, which may animate an associated avatar 112, allowing other users of system 100 to see the changes.

As another example, if a user does not have access to a head mounted device 104 or wish to not use one, a user may still interact with system 100. The user may use a device (e.g., computing device 106) and may select an object using an input device (e.g., touchpad, mouse, keyboard, trackball, etc.) and move the object to a different location. Any relocation of the object is sent to processing unit 108 and generated area of interest 122 may be “refreshed” such that other users of system 100 may see the changes.

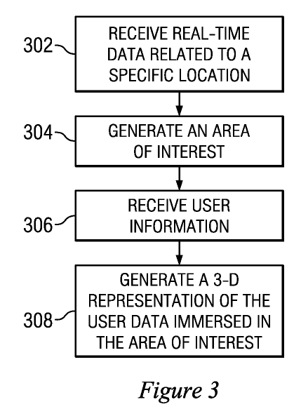

FIG. 3 illustrates a flow chart of another example method 300 for immersing users in a three-dimensional, real-time area of interest, in accordance with embodiments of the present disclosure. At step 302, processing unit 108 may receive real-time data from, for example, real-time imaging system 114 related to a specific location (e.g., battlefield, airspace, etc.). In some embodiments, the data may include GPS coordinates, satellite images, locations of objects (e.g., buildings, tanks, troops, aircraft or other landmarks) and/or weather conditions. In some embodiments, data related to loitering munitions locations, battlefield geometries, sensor locations and coverage, aircraft locations, satellite and UAV imagery, targeting information, and/or intelligence information related to area of interest 122 may also be received by processing unit 108. In the same or alternative embodiments, data related to other objects located in the specific location may also be received.

At step 304, processing unit 108 may generate a three-dimensional graphical representation of area of interest 122 based at least on the data received at step 302. In some embodiments, processing unit 108 may retrieve graphical icons, terrain maps, graphical representation of objects, and/or other symbols stored in memory 120 that may represent the received data. For example, in step 302, processing unit 108 may receive data for an area of interest that may include mountains, terrains, bodies of water, etc. Processing unit 108 may also receive data relating to objects such as aircraft, tanks, building, etc. Processing unit 108 may retrieve graphical icons that represent the terrain as well as the objects location from memory 120 and may generate a 3D representation of the specific location, e.g., area of interest 122 using the retrieved graphical icons and/or symbols.

At step 306, processing unit 108 may receive user information. In some embodiments, processing unit 108 may receive gesture information from one or more cameras 102. In the same or alternative embodiments, processing unit 108 may receive user information from computing device 106. Processing unit 108 may also receive user-related data including, for example, voice and/or text communication and/or manipulation of one or more objects in area of interest 120.

At step 308, processing unit 108 may generate a 3D representation of the user data immersed in the generated area of interest (step 304). In some embodiments, based on the data received from one or more cameras 102 via a video stream, processing unit may generate a 3D avatar 112 of the user, and based on the gesture(s) data, animate avatar 112 to reflect the gesture(s) of the user. For example, if the user is motioning and pointing to a specific location within area of interest 122, camera 102 may capture that motion (e.g., finger pointing) and may send the motion to processing unit 108. Processing unit 108 may animate avatar 112 associated with the user to mimic the same motion.

In some embodiments, the user information received may be voice and/or text communication. Processing unit 108 may determine if the voice and/or text communication can be seen and/or heard by all users and may relay the voice and/or text to the appropriate user(s). For example, if the voice communication is relaying strategic information between commanders of a military mission, processing unit 108 may determine which users are commanders and which users are tactical team members based on credentials provided by the user. Processing unit 108 may filter the user and subsequently relay the communication if the user satisfies the credentials via, for example, earphones coupled to head mounted device 104.

Processing unit may also receive manipulation of objects or change in vantage point data in step 306. In some embodiments, the user may be wearing head mounting device 104 and may use gestures to select an object displayed in generated area of interest 122. Alternative, a user may use computing device 106 to manipulate the location of an object. If a user changes the location of an object from point X to point Y in area of interest 122, processing unit 108 may “refresh” area of interest 122 such that other users of system 100 may see the changes in substantially real-time.

The systems and methods provided in the present disclosure may provide substantially real-time networking of two or more remote users immersed in a substantially real-time rendering of an area of interest. While the present disclosure provides specific examples described above, it is noted that the systems and methods may be used for other planning, command and control applications where 3D representation of remote users immersed in an area of interest.

Although the present disclosure has been described in detail, it should be understood that various changes, substitutions, and alterations may be made hereto without departing from the spirit and the scope of the invention as defined by the appended claims.

What is claimed is:

1. A method, comprising:
receiving substantially real-time data related to an area of interest;
generating a three-dimensional representation of the area of interest using the received real-time data related to the area of interest;
receiving substantially real-time data related to a plurality of users, each of the plurality of users located in a remote location, and wherein the substantially real-time data comprising gesture data; and
generating a three-dimensional representation of the plurality of users based at least on the received real-time data related to the plurality of users, the three-dimensional representation of each of the plurality of users immersed in the three-dimensional representation of the area of interest.

2. The method according to claim 1, wherein the received data related to the area of interest comprises at least one of: substantially real-time object location information, object data, and substantially real-time weather information.

3. The method according to claim 1, further comprising dynamically integrating graphical representation of new real-time data related to the area of interest to the generated three-dimensional representation of the area of interest.

4. The method according to claim 1, wherein receiving as input substantially real-time data related to a plurality of users comprises receiving as input from at least one camera associated with each of the plurality of users.

5. The method according to claim 1, wherein receiving as input substantially real-time data related to a plurality of users comprises receiving as input from a computing device associated with each of the plurality of users.

6. The method according to claim 1, wherein receiving substantially real-time data related to a plurality of users further comprising receiving communication data and manipulation data, wherein manipulation data comprises the data associated with the manipulation of objects in the area of interest.

7. The method according to claim 1, wherein generating a three-dimensional representation of the received data related to an area of interest comprises retrieving a graphical icon representing the received data.

8. The method according to claim 1, displaying the three-dimensional representation of each of the plurality of users immersed in the displayed three-dimensional representation of the area of interest further comprises animating the three-dimensional representation based at least on the received gesture data.

9. The method according to claim 1, wherein the communication data comprises at least one of a visual communication signal, an audio communication signal, and/or a visual and audio communication signal.

10. The method according to claim 9, further comprising delivering the communication data to at least one of the plurality of users based on credentials of the at least one of the plurality of users.

11. A system, comprising:
a camera configured to capture real-time data related to a user of a plurality of users;
a real-time imaging system configured to provide substantially real-time data related to an area of interest;
a processing unit coupled to the camera and real-time imaging system the processing unit configured to:
receive substantially real-time data related to an area of interest;
generate a three-dimensional representation of the area of interest using the received real-time data related to the area of interest;
receive substantially real-time data related to each of the plurality of users, wherein each of the plurality of users located in a remote location, and wherein the substantially real-time data comprising gesture data; and
generate a three-dimensional representation for each of the plurality of users based at least on the received real-time data related to each of the plurality of users, the three-dimensional representation of each of the plurality of users immersed in the three-dimensional representation of the area of interest.

12. The system according to claim 11, wherein the received data related to the area of interest comprises at least one of: substantially real-time object location information, object data, and substantially real-time weather information.

13. The system according to claim 11, the processing unit is further configured to receive as input substantially real-time data related to a plurality of users comprises receiving as input from a computing device associated with each of the plurality of users.

14. The system according to claim 11, wherein to generate a three-dimensional representation of the received data related to an area of interest, the processing unit may be configured to retrieve a graphical icon representing the received data.

15. The system according to claim 11, wherein the processing unit is further configured to dynamically integrate new real-time data related to the area of interest to the generated three-dimensional representation of the area of interest.

16. The system according to claim 11, wherein displaying the three-dimensional representation of each of the plurality of users immersed in the displayed three-dimensional representation of the area of interest further comprises the processing unit configured to animate the three-dimensional representation based at least on the received gesture data.

17. The system according to claim 11, wherein the communication data comprises at least one of a visual communication signal, an audio communication signal, and/or a visual and audio communication signal.

18. The system according to claim 17, wherein the processing unit is further configured to deliver the communication data to at least one of the plurality of users based on credentials of the at least one of the plurality of users.

19. A method, comprising:
generating a three-dimensional area of interest based at least on substantially real-time data;
generating an avatar immersed in the generated three-dimensional area of interest for each user of a plurality of users;
animating each avatar immersed in the generated three-dimensional representation of area of interest based at least on gesture data received from one or more cameras associated to each user of the plurality of users; and
manipulating objects represented in the three-dimensional representation of the area of interest.

20. The method according to claim 19, wherein manipulating objects comprises manipulating the object based at least on the gesture data.
